(19) United States
(12) Patent Application Publication
(10) Pub. No.: US 2018/0224950 A1
(43) Pub. Date: Aug. 9, 2018

(54) INFORMATION PROCESSING SYSTEM AND INFORMATION PROCESSING METHOD THEREOF

(71) Applicant: Electronics and Telecommunications Research Institute, Daejeon (KR)

(72) Inventors: Ji Eun KIM, Daejeon (KR); Jun Seong BANG, Daejeon (KR); Hun Joo LEE, Daejeon (KR)

(73) Assignee: Electronics and Telecommunications Research Institute, Daejeon (KR)

(21) Appl. No.: 15/708,291

(22) Filed: Sep. 19, 2017

(30) Foreign Application Priority Data
Feb. 7, 2017 (KR) 10-2017-0016893

(51) Int. Cl. G06F 3/0346; G06K 9/00; G06K 9/46; A63F 13/40; A63F 13/213; A63F 13/812; A63F 13/285

(52) U.S. Cl. CPC G06F 3/0346; G06K 9/00335; G06K 9/4604; G06F 3/016; A63F 13/213; A63F 13/812; A63F 13/285; A63F 13/40

(57) ABSTRACT

Provided is an information processing system implemented to allow various types of services, such as virtual reality games or augmented reality games, to be enjoyed with a perception of reality by using a single manipulation device that may be modified in various forms, and an information processing method thereof. The information processing system includes: a manipulation device including a plurality of fragments each having distinguishment information for distinguishing the plurality of fragments from each other, the manipulation device configured to provide motion information according to a manipulation of a user; and an information processing device configured to provide various types of services by reflecting the motion information received from the manipulation device and a result of processing an image of the manipulation device on basic content for a service.

### CROSS-REFERENCE TO RELATED APPLICATION

This application claims priority to and the benefit of Korean Patent Application No. 2017-0016893, filed on Feb. 7, 2017, the disclosure of which is incorporated herein by reference in its entirety.

### BACKGROUND

### 1. Field of the Invention

The present invention relates to an information processing system and an information processing method, and more particularly, to an information processing system implemented to allow various types of services, such as virtual reality games or augmented reality games, to be enjoyed with a perception of reality by a single manipulation device, and an information processing method thereof.

### 2. Discussion of Related Art

A virtual reality or augmented reality service is a service that allows the virtual reality or augmented reality to appear in real so that a human using the service feels a sensation of experiencing the virtual reality or augmented reality, and it is based on a human-computer interaction.

As a system allowing a user to interact with a virtual object or environment with a perception of real, there is an information processing system including a motion controller, for example, Nintendo Wii or Sony Move.

Such an information processing system operates by recognizing a direction in which a bar-type motion controller gripped by a user's hand is moved by a camera or a motion sensor, and processing the motion of the bar-type motion controller in connection with contents.

For example, when a user takes a motion of moving the motion controller downward or upward while holding the motion controller in a longitudinal direction, the information processing system recognizes the form and motion of the motion controller and connects a result of the recognition to an attack and a defense of a virtual sword object.

Alternatively, when a user takes a motion of tilting the motion controller leftward or rightward while holding the motion controller in a traverse direction, the information processing system recognizes the form and motion of the motion controller and connects a result of the recognition to leftward and rightward switches of a virtual steering wheel.

However, the existing system is only suitable for the contents that require attributes of direction change, but is hardly applied to contents that require attributes of size/volume/speed/pressure change.

### SUMMARY OF THE INVENTION

The present invention is directed to provide an information processing system implemented to allow various types of services, such as virtual reality games or augmented reality games, to be enjoyed with a perception of reality by using a single manipulation device that may be modified in various forms, and an information processing method thereof.

The technical objectives of the present invention are not limited to the above disclosure, and other objectives may become apparent to those of ordinary skill in the art based on the following descriptions.

To achieve the above-described objectives, an information processing system according to an embodiment of the present invention includes: a manipulation device including a plurality of fragments each having distinguishment information for distinguishing the plurality of fragments from each other, the manipulation device configured to provide motion information according to a manipulation of a user; and an information processing device configured to provide various types of services by reflecting the motion information received from the manipulation device and a result of processing an image of the manipulation device on basic content for a service, wherein the information processing device includes: a camera module configured to obtain an image of the manipulation device; an input module configured to receive a setting related to a type of a service to be provided and output a setting signal; and a processing module configured to determine object attribute information in content that is provided by the service, on the basis of a result of recognizing the motion information received from the manipulation device and determine object information that is provided by the service on the basis of a result of processing the image received from the camera module, and to provide the service on which the determined object information and the determined object attribute information are reflected.

An information processing method according to an embodiment of the present invention includes: providing basic content for providing a service corresponding to a setting signal that is input according to a user's selection; obtaining motion information and an image related to a manipulation device which change according to a manipulation of a user using a service; extracting an motion number corresponding to the motion information by analyzing the motion information and extracting an arrangement number corresponding to an arrangement of fragments forming the manipulation device by analyzing the image; determining object information corresponding to the arrangement number and object attribute information corresponding to the motion number; and extracting an object corresponding to the object information and providing a service by reflecting the object operating according to the object attribute information on the basic content.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a view illustrating an example of a configuration of an information processing system according to an exemplary embodiment of the present invention;

FIG. 2 is a view illustrating a form of an example of a manipulation device according to an exemplary embodiment of the present invention;

FIG. 3 is a view illustrating a configuration of an example of a manipulation module of a manipulation device according to an exemplary embodiment of the present invention;

FIG. 4 is a view illustrating a configuration of an example of a feedback information output part of a manipulation device according to an exemplary embodiment of the present invention;

FIG. 5 is a view illustrating a configuration of an example of an electronic circuit module of a manipulation device according to an exemplary embodiment of the present invention;

FIG. 6 is a view illustrating a configuration of an example of a processing module of an information processing device according to an exemplary embodiment of the present invention;

FIG. 7 is a view illustrating a configuration of an example of an image processing part of a processing module according to an exemplary embodiment of the present invention;

FIG. 8 is a flowchart showing an operation of an information processing system according to an information processing method according to an exemplary embodiment of the present invention;

FIG. 9A is a view illustrating a front side of an example of a manipulation device used in an information processing system according to an exemplary embodiment of the present invention;

FIG. 9B is a view illustrating a rear side of the manipulation device shown in FIG. 9A;

FIG. 10 is an example of a table that shows arrangement numbers according to an arrangement of fragments when the manipulation device shown in FIGS. 9A and 9B is used;

FIG. 11 is an example of a table that shows motion numbers according to operations of the manipulation device when the manipulation device shown in FIGS. 9A and 9B is used;

FIG. 12 is a view illustrating attributes related to an object which are defined by a manipulation device according to an embodiment of the present invention; and

FIGS. 13A and 13B are views illustrating an operation that is implemented in content according to an arrangement and motion of a manipulation device when an information processing system according to the present invention is applied to a bowling game content.

### DETAILED DESCRIPTION OF EXEMPLARY EMBODIMENTS

Example embodiments of the present invention are disclosed herein. However, specific structural and functional details disclosed herein are merely representative for purposes of describing example embodiments of the present invention, and the example embodiments of the present invention may be embodied in many alternative forms and are not to be construed as limited to the example embodiments of the present invention set forth herein.

Accordingly, while the invention is susceptible to various modifications and alternative forms, specific embodiments thereof are shown by way of example in the drawings and will herein be described in detail. However, it should be understood that there is no intent to limit the invention to the particular forms disclosed, rather the invention is to cover all modifications, equivalents, and alternatives falling within the spirit and scope of the invention. Like numbers refer to like elements throughout the description of the figures.

It should be understood that, although the terms first, second, etc. may be used herein to describe various elements, these elements are not limited by these terms. These terms are only used to distinguish one element from another. For example, a first element could be termed a second element, and, similarly, a second element could be termed a first element, without departing from the scope of the present invention.

It should be understood that when an element is referred to as being “connected” or “coupled” to another element, the element can be directly connected or coupled to the other element or intervening elements may be present. Conversely, when an element is referred to as being “directly connected” or “directly coupled” to another element, there are no intervening elements present. Other words used to describe a relationship between elements should be interpreted in a like fashion (i.e., “between” versus “directly between,” “adjacent” versus “directly adjacent,” etc.).

The terminology used herein is for the purpose of describing particular embodiments only and is not intended to limit the invention. As used herein, the singular forms “a,” “an,” and “the” are intended to include the plural forms as well, unless the context clearly indicates otherwise. It should be further understood that the terms “comprises,” “comprising,” “includes,” and/or “including,” when used herein, specify the presence of stated features, integers, steps, operations, elements, components and/or groups thereof, and do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It should be further understood that terms, such as those defined in commonly used dictionaries, should be interpreted as having a meaning that is consistent with their meaning in the context of the relevant art and are not to be interpreted in an idealized or overly formal sense unless expressly so defined herein.

It should also be noted that in some alternative implementations, functions/actions noted in blocks may occur out of the order noted in flowcharts. For example, two blocks shown in succession may in fact be executed substantially concurrently or the blocks may sometimes be executed in a reverse order depending upon the functionality/actions involved.

Hereinafter, an information processing system and an information processing method thereof proposed by the present invention will be described in detail with reference to the accompanying drawings.

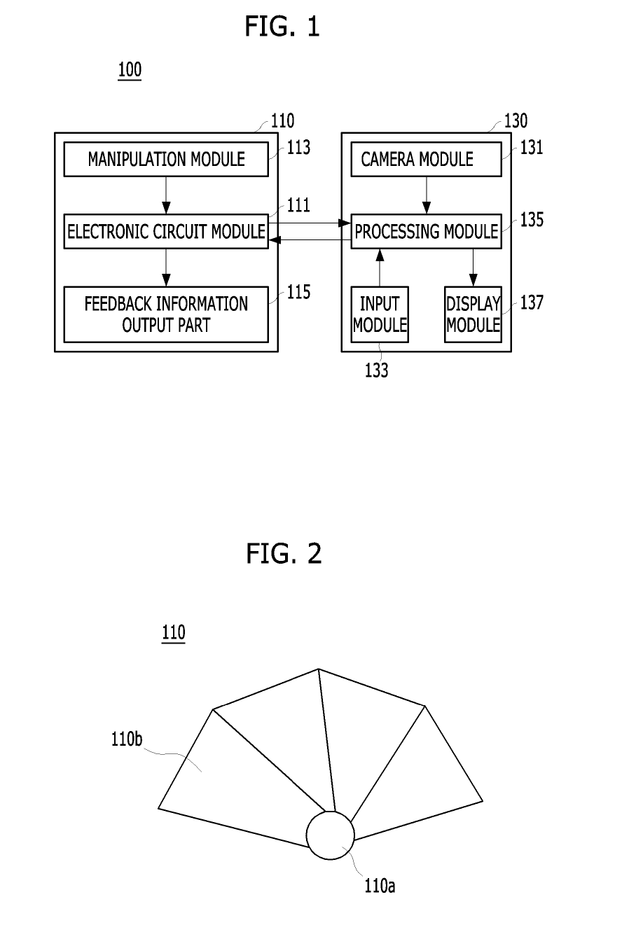

FIG. 1 is a view illustrating an example of a configuration of an information processing system according to an exemplary embodiment of the present invention.

Referring to FIG. 1, an information processing system 100 according to an exemplary embodiment of the present invention may include a manipulation device 110 and an information processing device 130.

In this case, the information processing system 100 proposed by the present invention may be available for virtual reality games or augmented reality games, for example. However, the application field of the information processing system is not limited thereto.

The information processing system 100 includes one or more storage modules configured to store information required for executing a function or a result of execution and one or more processors configured to execute a function.

In addition, the information processing system 100 may include a communication module for communication between components in the information processing system or communication between the information processing system and an external device.

First, referring to FIGS. 1 to 5, the configuration of the manipulation device 110 of the information processing system 100 according to an exemplary embodiment of the present invention will be described.

The manipulation device 110 is manipulated by a user who uses the information processing system to play a virtual reality game or an augmented reality game, and communicates with the information processing device 130 to perform a function.

In detail, the manipulation device 110 includes an electronic circuit module 111, a manipulation module 113, and a feedback information output part 115.

In this case, the manipulation device 110 may be implemented in the form of a foldable fan including a plurality of fragments as shown in FIG. 2.

FIG. 2 is a view illustrating a form of an example of a manipulation device according to an exemplary embodiment of the present invention.

Referring to FIG. 2, the manipulation device 110 includes a base fragment 110a and a plurality of blade fragments 110b each having one end connected to the base fragment 110a so as to be spread or folded with respect to the base fragment 110a.

Although the manipulation device 110 is exemplarily illustrated as having four blade fragments 110b, the present invention is not limited thereto. For example, the manipulation device 110 may include a larger number of blade fragments 110b.

In this case, the plurality of blade fragments 110b are provided to be distinguished from each other, and for this, include information (‘fragment distinguishment information’) that enables the plurality of blade fragments 110b to be distinguished from each other. The fragment distinguishment information may be a shape, a color, a pattern, a two-dimensional (2D) code (e.g., Quick Response (QR) code), light, and the like.

For example, in order to distinguish the blade fragments from each other, at least one selected from a shape, a color, a pattern, and a 2D code may be formed differently for each of the plurality of blade fragments 110b.

For example, in order to distinguish the blade fragments from each other, an optical element outputting light having a different feature may be disposed on each of the plurality of blade fragments 110b.

Meanwhile, the plurality of blade fragments 110b may be formed such that opposite sides of each blade fragment 110b are distinguished from each other. To this end, the plurality of blade fragments 110b may include information (‘opposite side distinguishment information’) that enables opposite sides of the blade fragment to be distinguished from each other. The opposite side distinguishment information may be a color, a pattern, a 2D code (e.g., QR code), and the like.

For example, in order to distinguish opposite sides of the blade fragment from each other, at least one selected from a color, a pattern, and a 2D code may be formed differently in opposite sides of each of the plurality of blade fragments 110b.

In this case, the electronic circuit module 111, the manipulation module 113, and the feedback information output part 115 may be disposed on any fragment among the plurality of fragments forming the manipulation device 110.

For example, the manipulation module 113 and the feedback information output part 115 may be disposed on the base fragment 110a, and a part of components of the electronic circuit module 111 may be disposed on the base fragment 110a, and another part of the components of the electronic circuit module 111 may be disposed on the blade fragment 110b.

The electronic circuit module 111 recognizes a motion of the manipulation device 110 and provides the information processing device 130 with motion information related to the manipulation device 110, and outputs feedback information received from the information processing device 130.

The feedback information may refer to a signal output from the information processing device 130 to inform that an operation according to the motion information received from the electronic circuit module 111 has been performed.

In addition, the electronic circuit module 111 outputs light having a different feature for each fragment (e.g., a color, a wavelength, and so on) such that the fragments of the manipulation device 110 are distinguished from each other.

Details of the construction and functions of the electronic circuit module 111 will be described later.

The manipulation module 113 is a component configured to perform a user control on the electronic circuit module 111, and the manipulation module 113 generates a manipulation signal according to a user's manipulation and outputs the generated manipulation signal to the electronic circuit module 111.

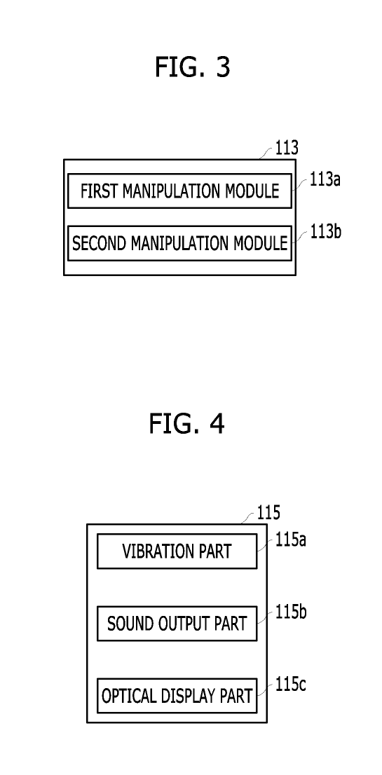

Referring to FIG. 3, the manipulation module 113 may include a plurality of sub-manipulation modules.

FIG. 3 is a view illustrating a configuration of an example of a manipulation module of a manipulation device according to an exemplary embodiment of the present invention.

Referring to FIG. 3, the manipulation module 113 may include a first manipulation module 113a and a second manipulation module 113b.

The first manipulation module 113a outputs a first manipulation signal for controlling an operation start and an operation end of the electronic circuit module 111 to the electronic circuit module 111.

In this case, the first manipulation module 113a outputs an operation start signal or an operation end signal according to a user's manipulation.

The second manipulation module 113b outputs a second manipulation signal for controlling an optical output start and an optical output end of the electronic circuit module 111 to the electronic circuit module 111.

In this case, the second manipulation module 113b may output an optical output start signal or an optical output end signal according to a user's manipulation.

The feedback information output part 115 may generate vibration, output sound or display light according to feedback information received from the information processing device 130.

In this case, the feedback information output part 115 operates according to a feedback signal, which is provided from the electronic circuit module 111, corresponding to the feedback information.

For example, referring to FIG. 4, the feedback information output part 115 may include a plurality of sub-components.

FIG. 4 is a view illustrating a configuration of an example of a feedback information output part of a manipulation device according to an exemplary embodiment of the present invention.

Referring to FIG. 4, the feedback information output part 115 may include a vibration part 115a configured to generate vibration according to the feedback signal, a sound output part 115b configured to output sound according to the feedback signal, and an optical display part 115c configured to display light according to the feedback signal.

For example, the vibration part 115a may be implemented using a vibration element (e.g., a vibration motor and so on), the sound output part 115b may be implemented using a sound generating element (e.g., a speaker and so on), and the optical display part 115c may be implemented using a light emitting device (e.g., a light emitting diode (LED)).

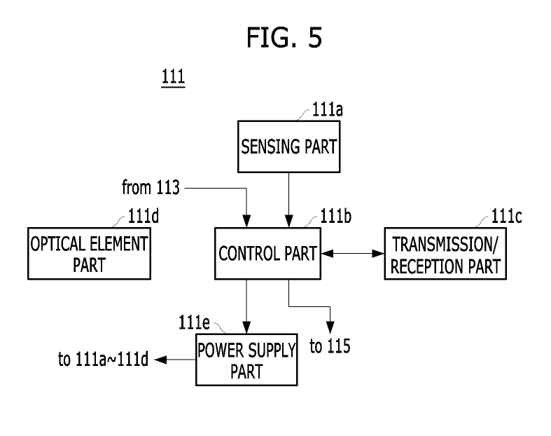

Hereinafter, the construction and functions of the electronic circuit module of the manipulation device according to an exemplary embodiment of the present invention will be described with reference to FIG. 5.

FIG. 5 is a view illustrating a configuration of an example of an electronic circuit module of a manipulation device according to an exemplary embodiment of the present invention.

Referring to FIG. 5, the electronic circuit module 111 recognizes a motion of the manipulation device 110 and provides the information processing device 130 with motion information related to the manipulation device 110, and outputs feedback information received from the information processing device 130.

In addition, the electronic circuit module 111 outputs light having a different feature for each fragment (e.g. a color, a wavelength, and so on) to distinguish the fragments of the manipulation device 110 from each other.

In detail, the electronic circuit module 111 may include a sensing part 111a, a control part 111b, a transmission/reception part 111c, an optical element part 111d, and a power supply part 111e. However, the construction of the electronic circuit module 111 is not limited thereto.

The sensing part 111a senses a changing motion of the manipulation device 110 when a user moves or performs a predetermined motion while holding the manipulation device 110, and provides the control part 111b with information related to the motion of the manipulation device 110 (motion information).

To this end, the sensing part 111a may include various types of sensors. For example, the sensing part 111a may include an acceleration sensor, a gyro sensor, a geomagnetic sensor, a physical button sensor, a touch pad sensor, a proximity sensor, and so on.

The control part 111b is implemented using a processor, and is implemented to start or end operating according to a first manipulation signal received from the manipulation module 113. In this case, the first manipulation signal may be an operation start signal or an operation end signal.

The control part 111b provides the transmission/reception part 111c with the motion information received from the sensing part 111a, and receives feedback information from the transmission/reception part 111c.

In addition, the control part 111b generates a feedback signal according to the received feedback information and outputs the generated feedback signal to the feedback information output part 115.

In addition, the control part 111b controls an optical output operation of the optical element part 111d according to a second manipulation signal received from the manipulation module 113. In this case, the second manipulation signal may be an optical output start signal or an optical output end signal.

The transmission/reception part 111c may be implemented using a communication module. The transmission/reception part 111c transmits the motion information received from the control part 111b to the information processing device 130, and provides the control part 111b with feedback information received from the information processing device 130.

In this case, the transmission/reception part 111c may be implemented to communicate with the information processing device 130 in a predetermined communication scheme that is selected among various types of wired/wireless communication schemes.

The optical element part 111d outputs light having a different feature (e.g., a color, a wavelength, and so on) for each fragment according to a control of the control part 111b such that the fragments of the manipulation device 110 are distinguished from each other.

To this end, the optical element part 111d may include a plurality of optical elements that are disposed on the plurality of fragments of the manipulation device 110, respectively, and are configured to each output light having a different feature.

The power supply part 111e is configured to supply power to the components in the electronic circuit module 111.

In addition, the power supply part 111e may be configured to supply power to other components of the manipulation device 110 (e.g. the manipulation module 113 and the feedback information output part 115) than the electronic circuit module 111.

The above description has been made in relation to the construction of the manipulation device 110 of the information processing system 100 according to an exemplary embodiment of the present invention with reference to FIGS. 1 to 5. Hereinafter, the construction of the information processing device 130 of the information processing system 100 according to an exemplary embodiment of the present invention will be described.

As shown in FIG. 1, the information processing device 130 may include a camera module 131, an input module 133, a processing module 135, and a display module 137. However, the configuration of the information processing device 130 is not limited thereto.

The camera module 131 acquires an image by imaging the manipulation device 110 and provides the processing module 135 with the acquired image. The camera module 131 may include one or more cameras.

The input module 133 is configured to set a service provided by the information processing device 130. A user may input the type of a service (e.g., a game) to be used by using the information processing system 100 through the input module 133.

The input module 133 generates a setting signal corresponding to a user's input for setting a service to be used, and outputs the generated setting signal to the processing module 135.

The processing module 135 receives an image related to the manipulation device 110 and transmitted from the camera module 131, a setting signal transmitted from the input module 133, and motion information related to the manipulation device 110 and transmitted from the manipulation device 110.

In addition, the processing module 135 provides a service corresponding to the setting signal, the service, on which image processing information generated as a result of processing the image and a motion recognition result generated as a result of recognizing the motion information are reflected, provided through the display module 137.

In this case, the processing module 135 determines an object and an object attribute in content provided by a service, on the basis of the image processing information and the motion recognition result, and provides the service, on which the determined object and the determined object attribute are reflected, through the display module 137.

Details of the construction and functions of the processing module 135 will be described later with reference to the accompanying drawings.

The display module 137 displays a service provided from the processing module 135.

For example, the display module 137 may be implemented by including a liquid crystal display (LCD) panel, or organic light emitting diode (OLED) panel. However, the implementation of the display module 137 is not limited thereto.

Hereinafter, the construction and the functions of the information processing device according to an exemplary embodiment of the present invention will be described with reference to the accompanying drawings.

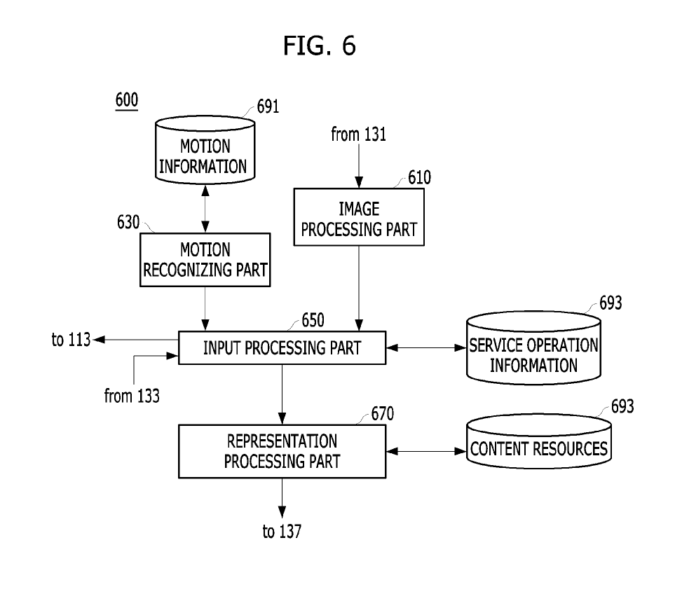

FIG. 6 is a view illustrating a configuration of an example of a processing module of an information processing device according to an exemplary embodiment of the present invention.

A processing module 600 shown in FIG. 6 may be applied to the processing module 135 shown in FIG. 1, and may include an image processing part 610, a motion recognizing part 630, an input processing part 650, and a representation processing part 670.

The image processing part 610 receives an image from the camera module 131, processes the received image, and outputs an image processing result generated as a result of processing the received image to the input processing part 650.

In detail, the image processing part 610 recognizes a feature of each fragment of the manipulation device in the image, identifies the fragment included in the image by analyzing the recognized feature of each fragment, recognizes an arrangement sequence of the fragment in the image on the basis of a result of the identification, and outputs an arrangement number corresponding to the recognized arrangement sequence to the input processing part 650 as an image processing result.

Details of the construction and functions of the image processing part 610 will be described below with reference to the accompanying drawings.

The motion recognizing part 630 may be associated with a first database 691 that stores a motion number for each motion, so as to extract required information from the first database 691.

In addition, the motion recognizing part 630 recognizes a motion of the manipulation device 110 by analyzing motion information received from the manipulation device 110 and extracts a motion number corresponding to the recognized motion from the first database 691, and outputs the extracted motion number to the input processing part 650 as a motion recognition result.

The input processing part 650 receives the setting signal transmitted from the input module 133, the arrangement number transmitted from the image processing part 610, and the motion number transmitted from the motion recognizing part 630.

In addition, the input processing part 650 may be associated with a second database 693 that stores service operation information, so as to extract required information from the second database 693.

In this case, the service operation information includes object information corresponding to an arrangement number and object attribute information corresponding to a motion number.

Meanwhile, since the information processing system 100 according to the present invention is implemented in order to provide various types of services (e.g., different types of games) by using a single manipulation device, an object for a certain one arrangement number (arrangement number 1) and an object attribute for a certain one motion number (motion number 1) need to be different for each type of services (e.g., each type of a game).

Accordingly, the second database 693 stores a plurality of pieces of service operation information, and the plurality of pieces of service operation information are stored to match setting signals, respectively.

For example, first service operation information is stored to match a first setting signal, and second service operation information is stored to match a second setting signal.

That is, an object for arrangement number 1 in the first service operation information and an object for arrangement number 1 in the second service operation information are different from each other. For example, an object for arrangement number 1 in the first service operation information is a ‘bowling ball’, and an object for arrangement number 1 in the second service operation information is a ‘form block’.

The input processing part 650 may extract object information corresponding an arrangement number and object attribute information corresponding to a motion number from the second database 693.

In this case, the input processing part 650 extracts the object information and the object attribute information from service operation information corresponding to a setting signal.

In addition, the input processing part 650 outputs the extracted object information and the extracted object attribute information to the representation processing part 670.

In addition, the input processing part 650 may output feedback information for informing that an operation according to the motion information received from the manipulation device 110 has been performed to the manipulation device 110, while outputting the extracted object information and object attribute information or after outputting the extracted object information and object attribute information to the representation processing part 670.

The representation processing part 670 receives object information and object attribute information from the input processing part 650, and outputs a content object corresponding to the object information, which operates according to the object attribute information, on the display module 137.

In addition, the representation processing part 670 may be associated with a third database 695 that stores content resources, to extract required information from the third database 695.

Hereinafter, details of the construction and functions of the image processing part of the processing module according to an exemplary embodiment of the present invention will be described below with reference to the accompanying drawing.

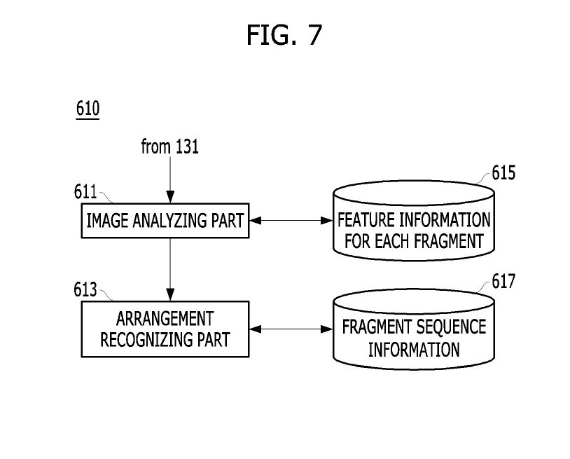

FIG. 7 is a view illustrating a configuration of an example of an image processing part of a processing module according to an exemplary embodiment of the present invention.

Referring to FIG. 7, the image processing part 610 receives an image from the camera module 131, processes the received image, and outputs an image processing result generated as a result of processing the image to the input processing part 650.

In detail, the image processing part 610 recognizes a feature of each fragment of the manipulation device in the image, identifies the fragment on the basis of the recognized feature of each fragment, recognizes an arrangement sequence of the fragment in the image on the basis of a result of the identification, and outputs an arrangement number corresponding to the recognized arrangement sequence to the input processing part 650 as an image processing result.

To this end, the image processing part 610 may include an image analyzing part 611, an arrangement recognizing part 613, a fourth database 615, and a fifth database 617.

The image analyzing part 611 is associated with the fourth database 615 that stores feature information (e.g., fragment information, opposite side distinguishment information) that is used to distinguish fragments from each other, and extracts required information from the fourth database 615.

The image analyzing part 611 receives an image from the camera module 131, and identifies a fragment of the manipulation device in the image by analyzing the received image.

In particular, the image analyzing part 611 divides the manipulation device included in the image into a plurality of fragments on the basis of an outline, and recognizes features of the respective fragments divided.

In this case, the image analyzing part 611 obtains feature information (e.g., a pattern, a color, a shape, a 2D code, light and the like) from the divided fragment, and compares the obtained feature information with feature information stored in the fourth database 615, thereby identifying the fragments in the image.

In addition, the image analyzing part 611 provides the arrangement recognizing part 613 with a result of identifying the fragment.

The arrangement recognizing part 613 is associated with the fifth database 617 that stores arrangement number information according to a sequence of fragments, and extracts required information from the fifth database 617.

The arrangement recognizing part 613 recognizes an arrangement sequence of a fragment on the basis of the identification result received from the image analyzing part 611, and extracts an arrangement number corresponding to the arrangement sequence from the fifth database 617 and outputs the extracted arrangement number to the input processing part 650.

The above description has been made in relation to the construction and the functions for the construction of the information processing system according to the exemplary embodiment of the present invention with reference to the accompanying drawings. Hereinafter, the information processing method of the information processing system according to an exemplary embodiment of the present invention will be described.

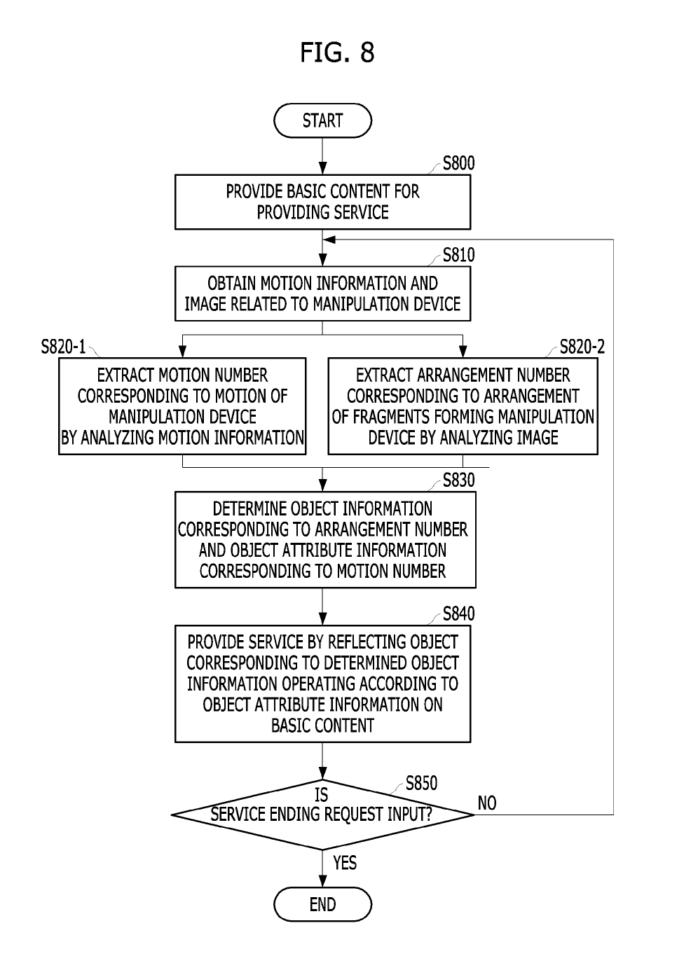

FIG. 8 is a flowchart showing an operation of an information processing system according to an information processing method according to an exemplary embodiment of the present invention.

The operation illustrated in FIG. 8 may be performed by the information processing system 100 described with reference to FIGS. 1 to 7. As a user uses a service provided by the information processing system 100, the information processing device 130 provides basic content for providing a service through the display module 137 (S800).

In this case, a user may select a desired service by using the input module 133 of the information processing device 130, and a setting signal according to the user's selection using the input module 133 is input into the information processing device 130, and the information processing device 130 provides a service corresponding to the setting signal.

As a service is provided by the information processing system 100 according to operation S800, the user manipulates the manipulation device 110 to use the service, and the manipulation device 110 provides the information processing device 130 with motion information related to the manipulation device 110 according to the user's manipulation (S810), and the camera module 131 acquires an image related to the manipulation device 110.

Accordingly, the information processing device 130 obtains the motion information and the image related to the manipulation device 110 (S810).

As the motion information and the image related to the manipulation device 110 are obtained according to operation S810, the information processing device 130 extracts a motion number corresponding to a motion of the manipulation device 110 by analyzing the motion information (S820-1) and extracts an arrangement number corresponding to an arrangement of fragments forming the manipulation device 110 by analyzing the image (S820-2).

In detail, in operation S820-1, the information processing device 130 recognizes a motion of the manipulation device 110 by analyzing motion information, and extracts a motion number corresponding to the recognized motion from the first database the 691.

Then, in operation S820-2, the information processing device 130 divides the manipulation device included in the image into a plurality of fragments on the basis of an outline of the manipulation device, identifies each fragment on the basis of a feature of each of the divided fragments, recognizes an arrangement sequence of the fragment on the basis of the identification result, and extracts an arrangement number corresponding to the arrangement sequence from the fifth database 617.

In operation S820-2, the information processing device 130 obtains feature information (e.g., a pattern, a color, a shape, a 2D code, light, and the like) from each of the divided fragments, and compares the obtained feature information of each of the divided fragments with fragment-specific feature information stored in the fourth database 615, thereby identifying each fragment.

That is, the obtaining of feature information from each of the divided fragments represents obtaining at least one selected from a shape, a color, a pattern, a 2D code, and light formed on each of the blade fragments to distinguish a plurality of blade fragments forming the manipulation device and opposite sides of each blade fragment.

After operations S820-1 and S820-2, the information processing device 130 determines object attribute information corresponding to the motion number and object information corresponding to the arrangement number by referring to the plurality of pieces of service operation information stored in the second database 693 (S830), and provides a service by reflecting the determined object information and the determined object attribute information on the basic content (S840).

In operation S830, the information processing device 130 determines motion number-specific object attribute information and arrangement number-specific object information by referring to service operation information that matches a setting signal that is input from the input module 133 according to a user's manipulation among the plurality of pieces of service operation information.

Meanwhile, in operation S830, the information processing device 130 outputs feedback information for informing that an operation according to motion information received from the manipulation device 110 has been performed to the manipulation device 110, and the manipulation device 110 may generate vibration, output sound, or display light to correspond to the feedback information.

In operation S840, the information processing device 130 may provide the determined object operating according to the determined attribute information in the basic content through the display module 137.

After operation S840, the information processing device 130 determines whether a service end request has been input (S850), and if it is determined that a service end request has not been input (No from S850), operation S810 is performed, and if it is determined that a service end request has been input (Yes from S850), a service being provided is ended.

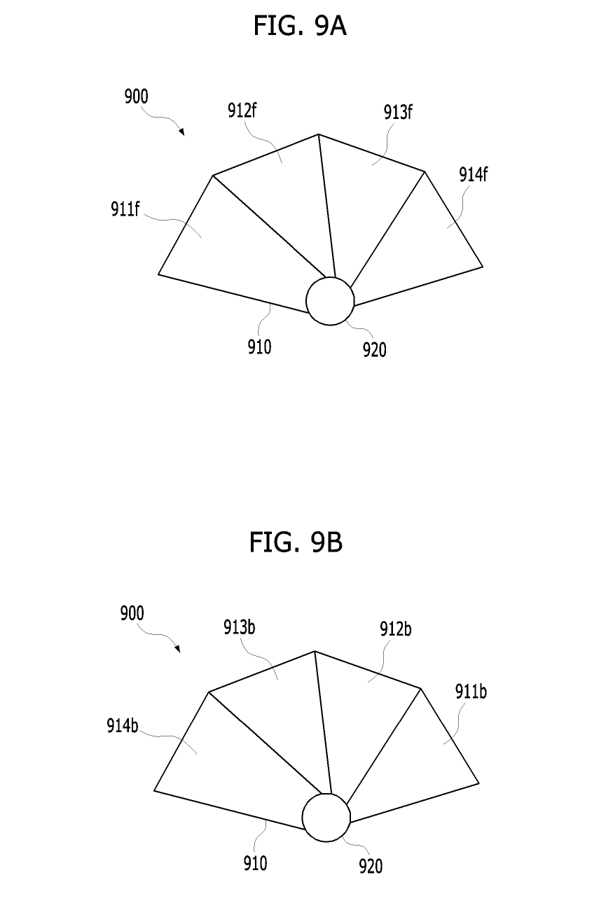

FIG. 9A is a view illustrating a front side of an example of a manipulation device used in an information processing system according to an exemplary embodiment of the present invention, and FIG. 9B is a view illustrating a rear side of the manipulation device shown in FIG. 9A.

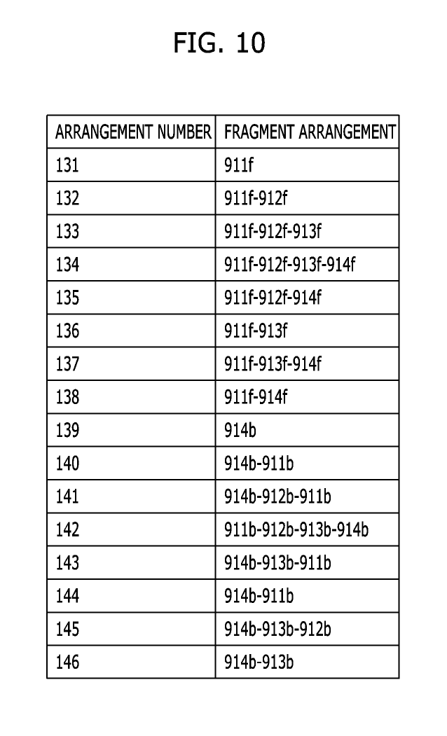

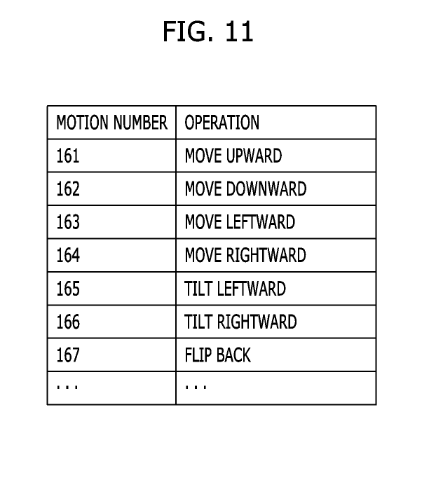

FIG. 10 is an example of a table showing arrangement numbers according to an arrangement of fragments when the manipulation device shown in FIGS. 9A and 9B is used, and FIG. 11 is an example of a table showing motion numbers according to operations of the manipulation device when the manipulation device shown in FIGS. 9A and 9B is used.

A manipulation device 900 illustrated in FIGS. 9A and 9B includes a base fragment 920 and four blade fragments 910 that are provided to be spreadable or foldable with respect to the base fragment 920.

However, the manipulation device 900 illustrated in FIGS. 9A and 9B is only an example. The shape and the number of fragments of the manipulation device may be variously implemented.

In addition, although each blade fragment of the manipulation device shown in FIGS. 9A and 9B includes information (e.g., a shape, a color, a pattern, a 2D code and light) for distinguishing the respective blade fragments from each other, such information for distinguishment may be set in various ways. For convenience of description, the respective blade fragments are illustrated as being distinguished from each other based on a reference numeral.

It is assumed that when the manipulation device 900 is constructed as shown in FIGS. 9A and 9B, and a matching table is set as shown in FIGS. 10 and 11, a user manipulates the manipulation device 900 to correspond to arrangement number 131 shown in FIG. 10 (i.e. with a front side of the manipulation device 900 positioned to be imaged by the camera module 131, a blade fragment 911f being spread, and blade fragments 912f, 913f and 914f being fold), and rapidly moves the manipulation device 900 upward from a lower position to correspond to motion number 161.

Under the above assumption, the information processing system 100 determines that the manipulation device has been moved as in motion number 161 in a state of being arranged as in arrangement number 131 by recognizing an arrangement of fragments and analyzing the motion information.

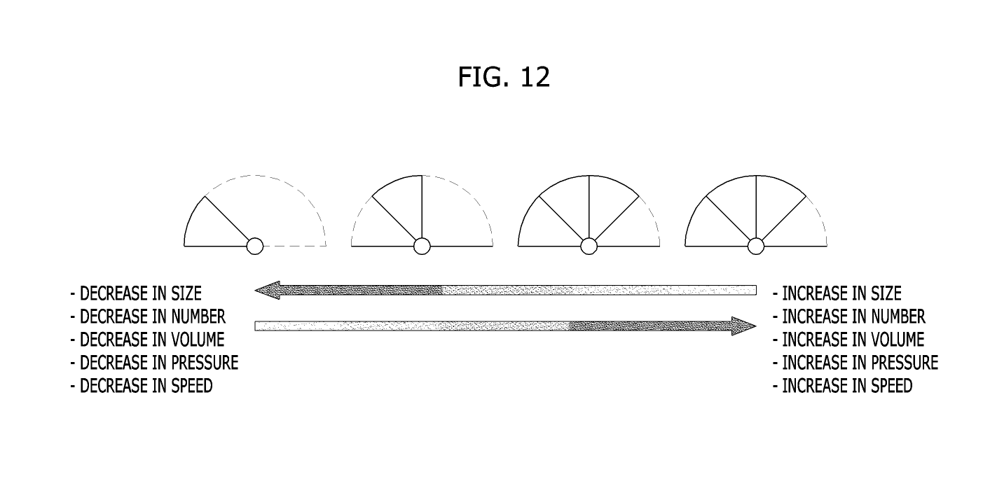

Meanwhile, FIG. 12 is a view illustrating attributes related to an object which are defined by a manipulation device according to an embodiment of the present invention.

Referring to FIG. 12, the size of an object, the number of objects, the volume of an object, the pressure of an object, and the speed of an object may be variously changed through manipulation of a manipulation device 1200.

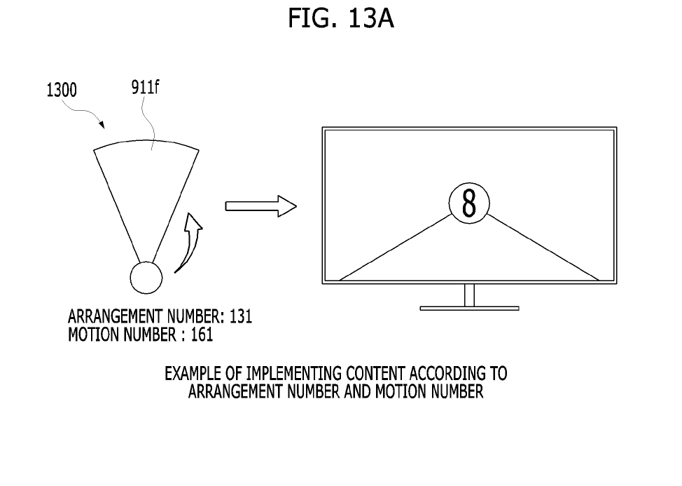

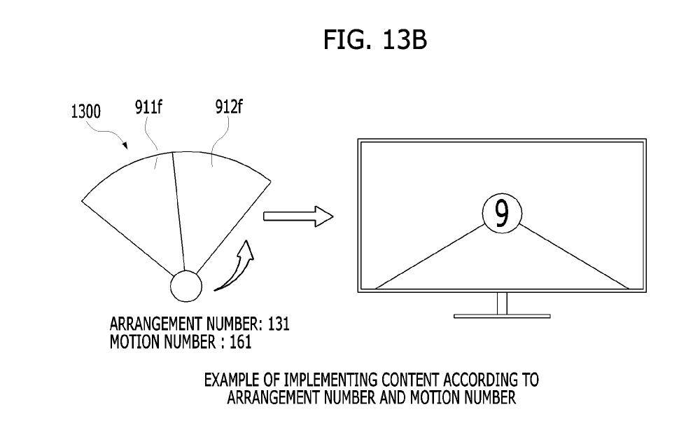

FIGS. 13A and 13B are views illustrating an operation that is implemented in content according to an arrangement and a motion of a manipulation device when an information processing system according to the present invention is applied to bowling game content.

Referring to FIG. 13A and 13B, it is assumed that a manipulation device 1300 has a structure as shown in FIGS. 9A and 9B and is associated with a virtual bowling object, and the arrangement of the manipulation device 1300 is related to the weight of the bowling object, and the manipulation device 1300 has motions according to the motion number table as shown in FIG. 11.

In addition, it is assumed that when the manipulation device 1300 is arranged as in FIG. 13A, that is, when the manipulation device 1300 is arranged as in arrangement number 131 shown in FIG. 10, the arrangement represents that the bowling object has a weight of eight pounds.

Similarly, it is assumed that when the manipulation device 1300 is arranged as in FIG. 13B, that is, when the manipulation device 1300 is arranged as in arrangement number 132 shown in FIG. 10, the arrangement represents that the bowling object has a weight of nine pounds.

Under the above assumption, when the manipulation device 1300 operates as in motion number 161 in a state of being arranged as in arrangement number 131 as shown in FIG. 13A, a bowling ball having a weight of eight pounds which moves forward along a bowling lane in bowling game content (a state in which a bowling ball having a weigh of eight pounds is rolled by a user) is displayed on a display screen.

In addition, when the manipulation device 1300 operates as in motion number 161 in a state of being arranged as in arrangement number 132 as shown in FIG. 13B, a bowling ball having a weight of nine pounds which moves forward along a bowling lane in bowling game content is displayed on a display screen.

As is apparent from the above, when the information processing system according to an exemplary embodiment of the present invention is used, various types of objects can be represented by using a single manipulation device, and object attributes also can be variously set.

In addition, even with the same arrangement of fragments or the same motion of the manipulation device, an object and an object attribute can be set differently for each type of a service, so that various types of service can be provided by using a single manipulation device.

Accordingly, when the information processing system according to the present invention is used, various games such as virtual reality games or augmented reality games can be provided with a perception of reality by using a single manipulation device that may be modified in various forms.

In the description above, although all of the components of the embodiments of the present invention may have been explained as assembled or operatively connected as a unit, the present invention is not intended to be limited to such embodiments. Rather, within the objective scope of the present invention, any number of the components may be selectively and operatively combined. Also, every one of the components may be implemented singly in hardware, while each of the components can also be selectively combined in part or as a whole and implemented in a computer program having program modules for executing functions of hardware equivalents thereof. The computer program may be stored in computer readable media, such as a USB memory, a compact disk (CD), a flash memory, and the like, which can realize the embodiments of the present invention when executed. The computer readable media include magnetic recording media, optical recording media, and carrier wave media.

As described above, although the information processing system and the information processing method thereof have been described with reference to the embodiments, the scope of the present invention is not limited to the specific embodiments. Those skilled in the art should appreciate that various modifications, changes, and substitutions to the embodiments are possible without departing from the scope and spirit of the invention.

Accordingly, the embodiments disclosed in the specification and drawings are illustrated to aid in the explanation and understanding of the present invention and are not intended to limit the scope spirit of the present invention. As such, it should be understood that other equivalents and modifications could be made thereto without departing from the spirit and scope of the invention defined by the appended claims.

What is claimed is:

1. An information processing system comprising:
a manipulation device including a plurality of fragments each having distinguishment information for distinguishing the plurality of fragments from each other, the manipulation device configured to provide motion information according to a manipulation of a user; and
an information processing device configured to provide various types of services by reflecting the motion information received from the manipulation device and a result of processing an image of the manipulation device on basic content for a service,
wherein the information processing device comprises:
a camera module configured to obtain an image of the manipulation device;
an input module configured to receive a setting related to a type of a service to be provided and output a setting signal; and
a processing module configured to determine object attribute information in content that is provided by the service, on the basis of a result of recognizing the motion information received from the manipulation device and determine object information that is provided by the service on the basis of a result of processing the image received from the camera module, and to provide the service on which the determined object information and the determined object attribute information are reflected.

2. The information processing system of claim 1, wherein the distinguishment information comprises fragment distinguishment information for distinguishing fragments from each other and opposite side distinguishment information for distinguishing opposite sides of the fragment from each other.

3. The information processing system of claim 1, wherein the distinguishment information comprises one or more selected from a shape, a color, a pattern, a two-dimensional (2D) code, and light,
wherein one or more selected from a shape, a color, a pattern, a 2D code, and light are formed differently in each of the plurality of fragments and opposite sides of each of the plurality of fragments.

4. The information processing system of claim 1, wherein the processing module comprises:
a motion recognizing part configured to recognize a motion of the manipulation device by analyzing the motion information and to extract a motion number corresponding to the recognized motion from a first database and output the extracted motion number;
an image processing part configured to identity a fragment included in the image by recognizing a feature for each fragment of the manipulation device in the image and to output an arrangement number corresponding to an arrangement sequence of a fragment recognized based on a result of the identification;
an input processing part configured to determine and output object attribute information corresponding to the motion number and object information corresponding to the arrangement sequence on the basis of a second database; and
a representation processing part configured to receive the object information and the object attribute information from the input processing part, extract an object corresponding to the object information from a third database, and provide a service by reflecting the object operating according to the object attribute information on the basic content.

5. The information processing system of claim 4, wherein the image processing part comprises an image analyzing part configured to divide the manipulation device in the image into a plurality of fragments on the basis of an outline, obtain feature information of each fragment divided, and compare the obtained feature information with feature information previously stored for fragment identification, to identify the fragments in the image; and
an arrangement recognizing part configured to recognize an arrangement sequence of the fragments on the basis of a result of the identification received from the image analyzing part, and output an arrangement number corresponding to the arrangement sequence.

6. The information processing system of claim 4, wherein the input processing part is configured to output feedback information for informing that an operation according to the motion information has been performed to the manipulation device, while outputting the object information and the object attribute information or after outputting the object information and the object attribute information.

7. The information processing system of claim 4, wherein the second database stores a plurality of pieces of service operation information each including arrangement signal-specific object information and motion signal-specific object attribute information to provide various types of services,
wherein the input processing part determines object information and object attribute information on the basis of arrangement signal-specific object information and motion signal-specific object attribute information in service operation information which matches the setting signal received from the input module among the plurality of pieces of service operation information.

8. The information processing system of claim 1, wherein the manipulation device comprises:
a manipulation module configured to output a manipulation signal according to a user's manipulation;
an electronic circuit module configured to recognize a motion of the manipulation device and provide the information processing device with motion information related to the manipulation device; and
a feedback information output part configured to output feedback information received from the information processing device, according to a control of the electronic circuit module.

9. The information processing system of claim 8, wherein the manipulation module comprises:
a first manipulation module configured to output a first manipulation signal for controlling an operation start and an operation end of the electronic circuit module to the electronic circuit module; and
a second manipulation module configured to output a second manipulation signal for controlling an optical output start and an optical output end of the electronic circuit module to the electronic circuit module.

10. The information processing system of claim 8, wherein the electronic circuit module comprises:
a sensing part configured to sense a changing motion of the manipulation device and output motion information related to the manipulation device;
a control part configured to provide the information processing device with the motion information received from the sensing part through a transmission/reception part, and to output a feedback signal corresponding to feedback information, which is received from the information processing device, to the feedback information output part;
an optical element part configured to output light according to a control of the control part; and
a power supply part configured to supply power to components in the electronic circuit module.

11. The information processing system of claim 10, wherein the optical element part comprises a plurality of optical elements that are disposed on the plurality of fragments of the manipulation device, respectively, and each are configured to output light having a different feature.

12. The information processing system of claim 11, wherein the control part controls the optical element part to output light according to a manipulation signal received from the manipulation module so that the plurality of fragments of the manipulation device are identified.

13. The information processing system of claim 10, wherein the feedback information output part comprises:
a vibration part configured to generate vibration according to the feedback signal;
a sound output part configured to output sound according to the feedback signal; and
an optical display part configured to display light according to the feedback signal.

14. An information processing method comprising:
providing basic content for providing a service corresponding to a setting signal that is input according to a user's selection;
obtaining motion information and an image related to a manipulation device which change according to a manipulation of a user using a service;
extracting a motion number corresponding to the motion information by analyzing the motion information and extracting an arrangement number corresponding to an arrangement of fragments forming the manipulation device by analyzing the image;
determining object information corresponding to the arrangement number and object attribute information corresponding to the motion number; and
extracting an object corresponding to the object information and providing a service by reflecting the object operating according to the object attribute information on the basic content.

15. The information processing method of claim 14, wherein the extracting of the motion number comprises: recognizing a motion of the manipulation device by analyzing the motion information; and extracting a motion number corresponding to the recognized motion from a first database.

16. The information processing method of claim 14, wherein the extracting of the arrangement number comprises: dividing the manipulation device in the image into a plurality of fragments on the basis of an outline, identifying each fragment on the basis of feature information of each fragment divided, recognizing an arrangement sequence of each fragment on the basis of a result of the identification, and extracting an arrangement number corresponding to the arrangement sequence from a fifth database.

17. The information processing method of claim 16, wherein the identifying of each fragment comprises obtaining feature information of each fragment divided, and comparing the obtained feature information for each fragment with feature information for each fragment stored in a fourth database, to identify each fragment.

18. The information processing method of claim 14, wherein the determining comprises determining object information and object attribute information on the basis of arrangement signal-specific object information and motion signal-specific object attribute information in service operation information which matches the setting signal among a plurality of pieces of service operation information that are stored in a second database to provide various types of service.

19. The information processing method of claim 14, further comprising:
outputting feedback information for informing that an operation according to the motion information has been performed to the manipulation device, when the object information and the object attribute information are determined; and
generating vibration, outputting sound, or displaying light according to the feedback information.

20. The information processing method of claim 17, the obtaining of feature information of each fragment comprises obtaining one or more selected from a shape, a color, a pattern, a two dimensional (2D) code, and light, which are formed in each of the plurality of fragments forming the manipulation device to distinguish the plurality of fragments and opposite sides of each of the plurality of fragments.
